(19) United States
(12) Patent Application Publication
(10) Pub. No.: US 2020/0265354 A1
(43) Pub. Date: Aug. 20, 2020

(54) Decision Making Entity Analytics Methods and Systems

(71) Applicant: BANCO BILBAO VIZCAYA ARGENTARIA, S.A., Bilbao (ES)

(72) Inventor: Escolástico Sanchez Martinez, Madrid (ES)

(73) Assignee: BANCO BILBAO VIZCAYA ARGENTARIA, S.A.

(21) Appl. No.: 15/699,291

(22) Filed: Sep. 8, 2017

(51) Int. Cl. G06Q 10/06; G06F 17/11; G06F 17/18

(52) U.S. Cl. CPC G06Q 10/0635; G06F 17/18; G06F 17/11

(57) ABSTRACT

An exemplary analytics system may determine a performance value that represents a performance achieved by a decision making entity. Based on the performance value, the analytics system may determine a carried out risk value that represents an amount of risk taken by the decision making entity to achieve the performance. The analytics system may also determine a risk budget that represents a range of risk within which the decision making entity is directed to operate. Based on the performance value, the carried out risk value, and the risk budget, the analytics system may generate a quantitative indicator that represents an effectiveness of the decision making entity. Corresponding systems and methods are also described.

### BACKGROUND INFORMATION

It is often desirable to objectively evaluate an effectiveness of a decision making entity, such as a portfolio manager, investment firm, business executive, or other person or organization that makes decisions. The objective evaluation may then be used to compare the decision making entity with other decision making entities, help the decision making entity make better decisions, and/or otherwise evaluate the decision making entity.

Unfortunately, conventional evaluation systems for decision making entities can produce misleading results and can sometimes encourage the decision making entities to make poor choices following a one-off decision that is exceptionally good or bad. For example, conventional evaluation systems for portfolio managers may take into account performance (e.g., a return of a portfolio) and carried out risk (i.e., the risk taken to achieve the performance). However, as will be described in more detail below, if a portfolio manager makes a decision that is exceptionally bad (e.g., that results in a negative return for the portfolio), the portfolio manager may be incentivized by the conventional evaluation systems to take higher than advisable risk with subsequent decisions.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows evaluation scores mapped to various percentiles of a normal distribution according to principles described herein.

FIG. 2 illustrates a graph that shows evaluation scores for a range of performance values and for various carried out risk values using a conventional evaluation approach that relies on performance and carried out risk according to principles described herein.

FIG. 3 illustrates an exemplary analytics system according to principles described herein.

FIG. 4 shows an exemplary graphical user interface according to principles described herein.

FIG. 5 shows an exemplary configuration in which an analytics system may be selectively and communicatively coupled to a computing device by way of a network according to principles described herein.

FIG. 6 illustrates an exemplary risk-budget based decision making entity analytics method according to principles described herein.

FIG. 7 illustrates an exemplary computing device according to principles described herein.

### DETAILED DESCRIPTION

Decision making entity analytics methods and systems are described herein. As will be described in more detail below, the methods and systems described herein may be configured to measure performance achieved by a decision making entity in a risk-managed way.

For example, an analytics system as described herein may determine a performance value that represents a performance achieved by a decision making entity. Based on the performance value, the analytics system may determine a carried out risk value that represents an amount of risk taken by the decision making entity to achieve the performance. The analytics system may also determine a risk budget that represents a range of risk within which the decision making entity is directed to operate. Based on the performance value, the carried out risk value, and the risk budget, the analytics system may generate a quantitative indicator that represents an effectiveness of the decision making entity. For example, the analytics system may generate the quantitative indicator by 1) determining a ratio of the performance value to the risk budget, 2) generating, based on the ratio of the performance value to the risk budget, a performance management-based quantitative indicator component, 3) determining a net number of predetermined time intervals (e.g., a net number of months) within an evaluation time period (e.g., a year) during which the carried out risk value is greater than the risk budget, 4) generating, based on the net number, a first risk management-based quantitative indicator component, 5) determining a quantity of deviation of the carried out risk value with respect to the risk budget, 6) generating, based on the quantity of deviation of the carried out risk value with respect to the risk budget, a second risk management-based quantitative indicator component, and 7) combining the performance management-based quantitative indicator component, the first risk management-based quantitative indicator component, and the second risk management-based quantitative indicator component. Each of these operations will be described in more detail below.

As used herein, a “decision making entity” may refer to a person, a group of people, an organization (e.g., a business entity), a computing device, and/or other entity that makes decisions with respect to assets or resources that are managed by the decision making entity. For example, a decision making entity may include a portfolio manager (which could be implemented by a person, organization, or computing device) that manages and makes decisions with respect to an investment portfolio, which may include a collection of assets (e.g., stocks, bonds, mutual funds, money market funds, etc.) and may be referred to simply as a “portfolio”. Other examples of decision making entities include, but are not limited to, investment firms, banks, management boards and/or their members, business executives, etc.

By taking into account the risk budget in evaluating an effectiveness of a decision making entity, as opposed using to just the performance and risk taken to achieve the performance, the methods and systems described herein may generate a quantitative indicator that more accurately and effectively quantifies the effectiveness of a decision making entity in managing both performance and risk, incentivizes the decision making entity to make wise decisions even after a one-off decision that is exceptionally good or bad, and allows the decision making entity and others to readily compare the decision making entity with other decision making entities.

In some examples, the methods and systems described herein require the use of one or more computing devices (e.g., multiple computing devices connected by way of a network). For example, an interconnected array of computing devices may be configured to generate and process data representative of performance values, carried out risk values, risk budgets, and quantitative indicators in a coordinated manner in order to evaluate and compare multiple decision making entities. Moreover, these computing devices may be configured to work in concert to generate and automatically adjust parameter datasets that govern how particular portfolios are managed by various different decision making entities in accordance with the determined quantitative indicators. In some examples, such adjustment of parameter datasets is performed in substantially real time by the computing devices as the portfolios are being managed by the decision maker entities. The methods and systems described herein may enable such computing devices to adjust the parameter datasets in a manner that is more efficient, effective, and accurate compared to conventional evaluation systems.

In some examples, the decision making entity is a computing device itself. For example, a computing device may be specifically configured to manage an investment portfolio by, for example, transmitting instructions that direct a server or the like to adjust the portfolio in accordance with a parameter dataset stored in memory of the computing device. Over time, the computing device may generate and update a quantitative indicator that represents an effectiveness of the computing device in managing the portfolio. Based on this quantitative indicator, the computing device may modify the parameter dataset stored by the computing device in a manner that is configured to improve the performance achieved by the computing device with respect to the portfolio. The computing device may then apply the modified parameter dataset to the management of the portfolio by transmitting, to the server, a command to adjust the portfolio in accordance with the modified parameter dataset. In this manner, the operation of the computing device with respect to the portfolio that the computing device is managing may be improved by the methods and systems described herein. This and other benefits and/or advantages that may be provided by the methods and systems described herein will be made apparent by the following detailed description.

To facilitate an understanding of some of the benefits provided by the methods and systems described herein, a brief explanation of a conventional approach to evaluating a decision making entity will now be provided. In this conventional evaluation approach, an information ratio is used to generate a quantitative indicator for a manager of a portfolio. The information ratio may be expressed as IR=(Rₚ−Rᵢ)/Sₚ₋ᵢ, where Rₚ is the return of the portfolio, Rᵢ is the return of a benchmark (e.g., an index to which the portfolio is being compared), and Sₚ₋ᵢ is the tracking error (i.e., the divergence between the price behavior of the portfolio and the price behavior of the benchmark).

The difference between Rₚ (i.e., the return of the portfolio) and Rᵢ (i.e., the return of a benchmark) can be referred to as the performance achieved by the portfolio manager, and Sₚ₋ᵢ (i.e., the tracking error) can be referred to as the carried out risk taken to achieve the performance. Hence, in this conventional evaluation approach, the quantitative indicator used to evaluate the portfolio manager is based on the ratio of the performance of the portfolio manager to the carried out risk taken by the portfolio manager to achieve the performance.

In some examples, the carried out risk (also referred to as the tracking error) may be determined by calculating the standard deviation of a number of performance values of the portfolio over a particular time period. For example, assume that the portfolio and the benchmark realize the following returns over a given five-year period:

Portfolio: 11%, 3%, 12%, 14% and 8%.

Benchmark: 12%, 5%, 13%, 9% and 7%.

Given this data, the series of differences is −1% (i.e., 11%−12%), −2% (i.e., 3%−5%), −1% (i.e., 12%−13%), 5% (i.e., 14%−9%) and 1% (i.e., 8% −7%). These differences are the performance values for the portfolio over the five year period. The standard deviation of this series of differences is the carried out risk, and is 2.79% in this example.

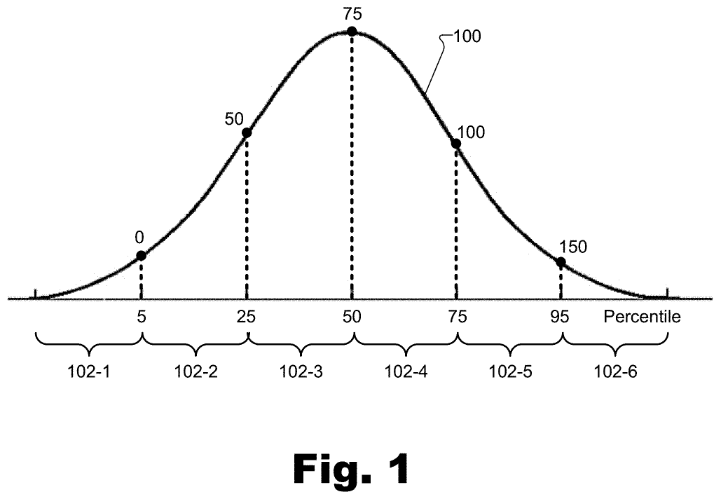

To determine the quantitative indicator that is to be assigned to the portfolio manager based on the information ratio for the portfolio manager, various evaluation scores are mapped to various percentiles of a normal distribution of information ratios with mean 0 and variance 1. For example, FIG. 1 shows various percentiles (i.e., 5, 25, 50, 75, and 95) of a normal distribution of values (in this case, information ratios), which is represented by bell curve 100. As shown, an evaluation score of 0 has been mapped to the 5th percentile, an evaluation score of 50 has been mapped to the 25th percentile, an evaluation score of 75 has been mapped to the 50th percentile, an evaluation score of 100 has been mapped to the 75th percentile, and an evaluation score of 150 has been mapped to the 95th percentile.

With these evaluation score mappings set, the information ratio for a particular portfolio manager may be determined and used to determine a qualitative indicator (i.e., an evaluation score) for the portfolio manager. For example, the information ratio for the portfolio manager may fall within a particular percentile range (e.g., one of ranges 102-1 through 102-6) of values within the normal distribution. If the information ratio for the portfolio manager falls within range 102-1, the portfolio manager may be deemed to be included in the worst five percent of “performers” and may be assigned an evaluation score (i.e., a quantitative indicator) of 0. Likewise, if the information ratio for the portfolio manager falls within range 102-2, the portfolio manager may be deemed to be included in the worst five to twenty-five percent of “performers” and may be assigned an evaluation score (i.e., a quantitative indicator) of somewhere between 0 and 50 (the exact number may be interpolated linearly between evaluation score 0 and 50). The evaluation score may be similarly determined if the information ratio for the portfolio manager falls within any of the other ranges 102-3 through 102-6.

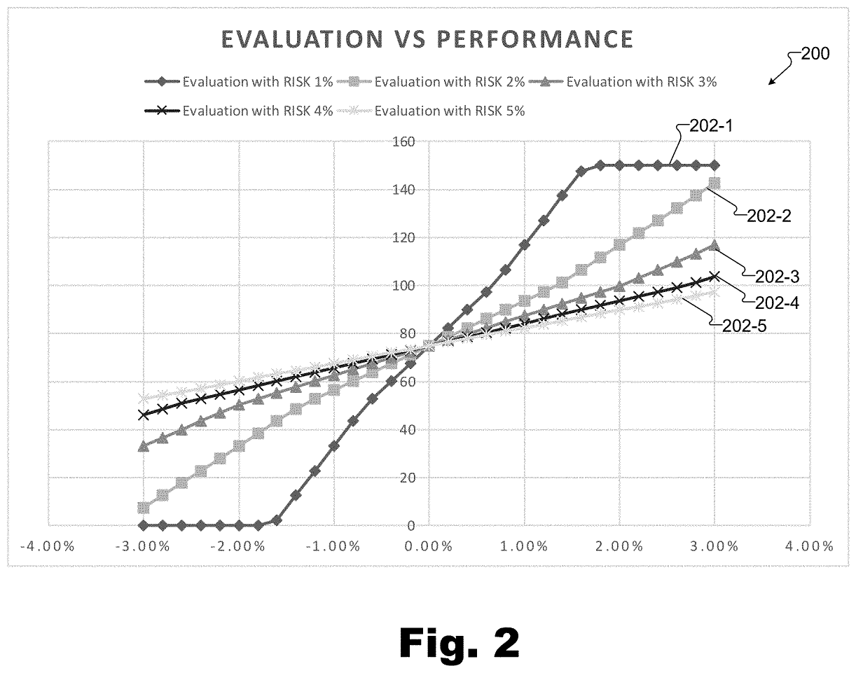

FIG. 2 illustrates a graph 200 that shows evaluation scores for a range of performance values and for various carried out risk values using the conventional evaluation approach that relies on performance and carried out risk described above. In the example of FIG. 2, performance values are shown on the horizontal axis and evaluation scores are shown on the vertical axis. As shown, the performance values range from −3% to 3%, and the corresponding evaluation scores range from 0 to 150. The evaluation scores may be determined based on the normal distribution of information ratios shown in FIG. 1.

In FIG. 2, line 202-1 represents evaluation scores for a range of performance values achieved with a carried out risk of 1%, line 202-2 represents evaluation scores for a range of performance values achieved with a carried out risk of 2%, line 202-3 represents evaluation scores for a range of performance values achieved with a carried out risk of 3%, line 202-4 represents evaluation scores for a range of performance values achieved with a carried out risk of 4%, and line 202-5 represents evaluation scores for a range of performance values achieved with a carried out risk of 5%.

Graph 200 shows several drawbacks of the conventional evaluation approach that relies on performance and carried out risk. In particular, if the performance value for a portfolio manager is negative, the portfolio manager knows that he or she will be guaranteed a higher evaluation score if he or she simply achieves the same performance value while taking a higher risk on a subsequent decision. For example, as shown by line 202-1, if the portfolio manager achieves a performance value of −2% with a carried out risk of 1%, the portfolio manager will receive an evaluation score of 0. Based on the slopes of lines 202-2 through 202-5, the portfolio manager will be guaranteed a higher evaluation score if the portfolio manager achieves the same performance value of −2% while taking any of the higher carried out risks of 2%-5%. For example, as shown by line 202-5, if the portfolio manager achieves a performance of −2% with a carried out risk of 5%, the portfolio manager will receive an evaluation score of 60. This may incentivize the portfolio manager to take higher than advisable risk after making a decision with respect to the portfolio that is exceptionally bad, for example.

Likewise, if the performance value for a portfolio manager is positive, the portfolio manager may be incentivized to take less than advisable risk for subsequent decisions in order to maintain or increase his or her evaluation score. This is especially the case when the portfolio manager achieves an exceptionally high performance value with a particular decision. For example, as shown by line 202-5, if the portfolio manager achieves a performance value of 3% with a carried out risk of 5%, the portfolio manager will receive an evaluation score of close to 100. In this case, the portfolio manager may be incentivized to reduce the amount of risk taken on subsequent decisions in order to maintain or increase his or her evaluation score. For example, as shown by line 202-1, the portfolio manager may decrease the carried out risk to 1% and receive the same or higher evaluation score by achieving a performance value of approximately 0.6%.

The methods and systems described herein obviate the drawbacks of the conventional evaluation approach that relies on performance and carried out risk as illustrated in FIG. 2. In particular, the methods and systems described herein generate a quantitative indicator (e.g., an evaluation score) for a decision making entity that is based in part on the decision making entity's risk budget. In this manner, as will be illustrated below, the quantitative indicator measures the ability of the decision making entity to achieve good performance while at the same time effectively managing the amount of risk taken to achieve the good performance.

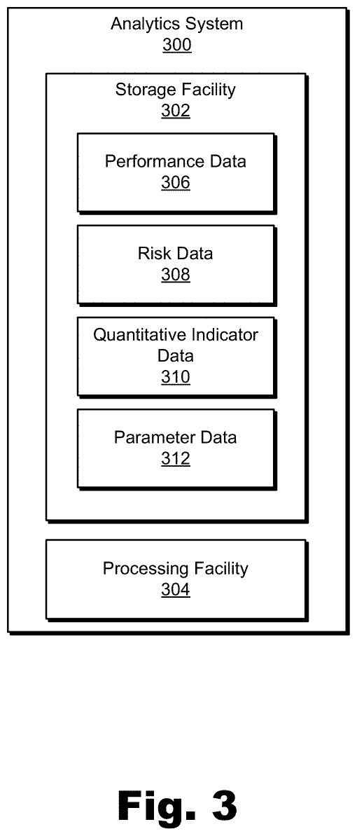

FIG. 3 illustrates an exemplary analytics system 300 (“system 300”) configured to perform the various decision making entity analytics operations described herein. As shown, system 300 may include, without limitation, a storage facility 302 and a processing facility 304 selectively and communicatively coupled to one another. It will be recognized that although facilities 302 and 304 are shown to be separate facilities in FIG. 3, facilities 302 and 304 may be combined into a single facility or divided into more facilities as may serve a particular implementation. System 300 may be implemented by one or more computing devices (i.e., one or more physical computing devices each comprising a processor and memory). Facilities 302 and 304 will now be described in more detail.

Storage facility 302 may maintain (e.g., store within memory of a computing device that implements system 300) various types of data received, generated, managed, used, and/or transmitted by processing facility 304. For example, as shown, storage facility 302 may maintain performance data 306, risk data 308, quantitative indicator data 310, and parameter data 312. Performance data 306 may include any data associated with or representative of a performance achieved by one or more decision making entities. For example, performance data 306 may include data representative of a performance value for a particular decision making entity, a return of a portfolio, a return of a benchmark, etc. Risk data 308 may include any data associated with or representative of a carried out risk taken by a decision making entity to achieve a particular performance value. Risk data 308 may additionally or alternatively include any data with or representative of a risk budget for the decision making entity. Quantitative indicator data 310 may include any data associated with or representative of a quantitative indicator (e.g., an evaluation score) for one or more decision making entities. Parameter data 312 may include any data associated with or representative of a parameter dataset that governs how particular portfolios are managed by various different decision making entities. Storage facility 302 may maintain additional or alternative data as may serve a particular implementation.

Processing facility 304 may perform various analytics operations associated with a decision making entity. For example, processing facility 304 may determine a performance value that represents a performance achieved by a decision making entity. Based on the performance value, processing facility 304 may determine a carried out risk value that represents an amount of risk taken by the decision making entity to achieve the performance. Processing facility 304 may also determine a risk budget that represents a range of risk within which the decision making entity is directed to operate. Based on the performance value, the carried out risk value, and the risk budget, processing facility 304 may generate a quantitative indicator that represents an effectiveness of the decision making entity. Each of these operations will now be described in more detail.

Processing facility 304 may determine a performance value that represents a performance achieved by a decision making entity in any suitable manner. For example, with respect to a portfolio managed by a portfolio manager, processing facility 304 may determine a return achieved by the portfolio (e.g., over a predetermined time period) and a return of a benchmark (e.g., over the same predetermined time period). Processing facility 304 may then determine the performance value by determining a difference between the return achieved by the portfolio and the return of the benchmark.

Processing facility 304 may acquire data representative of the return achieved by the portfolio and the return of the benchmark in any suitable manner. For example, processing facility 304 may receive such data from another computing device (e.g., a server) by way of a network. The data may be received automatically (e.g., periodically) by processing facility 304, in response to an input command provided by a user of system 300, and/or in any other suitable manner. Alternatively, processing facility 304 may acquire data representative of the return achieved by the portfolio and the return of the benchmark by generating the data based on input provided by a user of system 300 (e.g., by way of a graphical user interface presented by system 300).

In non-portfolio scenarios, processing facility 304 may determine the performance value by performing any suitable heuristic as may serve a particular implementation. For example, if decision making entity is a business entity, processing facility 304 may determine a performance value for the business based on any suitable metric used to measure a result of a decision made by the business entity.

Processing facility 304 may determine a carried out risk value that represents an amount of risk taken by the decision making entity to achieve the performance represented by the performance value in any suitable manner. For example, processing facility 304 may determine the carried out risk value by determining a standard deviation of a plurality of performance values achieved by the decision making entity over a particular time period. For example, as illustrated above, the performance values over a five year time period may be −1%, −2%, −1%, 5%, and 1%. In this example, the standard deviation (and therefore, the carried out risk value) for this dataset is 2.79%.

Processing facility 304 may determine a risk budget for a decision making entity in any suitable manner. As mentioned above, the risk budget represents a range of risk within which the decision making entity is directed to operate. For example, the risk budget may be specified by an entity that oversees the decision making entity. Additionally or alternatively, the risk budget may be automatically determined by processing facility 304 based on a previously carried out risk (e.g., a previous year's carried out risk for a portfolio), an average of previously carried out risks, the type of assets included in a portfolio managed by the decision making entity, a pattern change in the markets or in the economic environment associated with a portfolio managed by the decision making entity, and/or on any other factor as may serve a particular implementation. In some examples, the risk budget may change (e.g., on a monthly basis) in response to input provided by one or more users of system 300 (e.g., a supervisor of decision making entity).

In some examples, processing facility 304 may receive data representative of the risk budget by way of a network (e.g., from another computing device). Additionally or alternatively, processing facility 304 may determine the risk budget by performing one or more computing operations on data (e.g., data representative of previous carried out risk values) stored within storage facility 302. Additionally or alternatively, processing facility 304 may determine the risk budget by receiving user input (e.g., by way of a graphical user interface presented by system 300) representative of the risk budget.

As mentioned, processing facility 304 may generate a quantitative indicator that represents an effectiveness of the decision making entity based on the determined performance value, carried out risk value, and risk budget. This may be performed in any suitable manner. For example, processing facility 304 may generate the quantitative indicator by performing the following operations: 1) determine a ratio of the performance value to the risk budget, 2) generate, based on the ratio of the performance value to the risk budget, a performance management-based quantitative indicator component, 3) determine a net number of predetermined time intervals (e.g., a net number of months) within an evaluation time period (e.g., a year) during which the carried out risk value is greater than the risk budget, 4) generate, based on the net number, a first risk management-based quantitative indicator component, 5) determine a quantity of deviation of the carried out risk value with respect to the risk budget, 6) generate, based on the quantity of deviation of the carried out risk value with respect to the risk budget, a second risk management-based quantitative indicator component, and 7) combine the performance management-based quantitative indicator component, the first risk management-based quantitative indicator component, and the second risk management-based quantitative indicator component. Processing facility 304 may perform these operations in any suitable order as may serve a particular implementation. Moreover, at least some of these operations may be performed concurrently.

To illustrate the operations listed above that may be performed by processing facility 304 to generate a quantitative indicator for a decision making entity, the quantitative indicator may be represented by the following equation:

Q=w₁Qₚ+w₂Qᵣ₁+w₃Qᵣ₂ (Equation 1)

In this equation, Q represents the quantitative indicator (also referred to herein as the overall quantitative indicator) that will be given to the decision making entity based on the determined performance, carried out risk, and risk budget, Qₚ represents the performance management-based quantitative indicator component, Qᵣ₁ represents the first risk management-based quantitative indicator component, and Qᵣ₂ represents the second risk management-based quantitative indicator component. The variables w₁, w₂, and w₃ represent weighting values for Qₚ, Qᵣ₁, and Qᵣ₂, respectively, and may be set to weight each quantitative indicator component to have a desired amount of influence on the overall quantitative indicator. For example, w₁ may be set to 50%, w₂ may be set to 25%, and w₃ may be set to 25%, as will be described below. Hence, as illustrated by Equation 1, the overall quantitative indicator may indicate how well the decision making entity manages both performance and risk.

In Equation 1, the performance management-based quantitative indicator component (i.e., Qₚ) may be generated by determining a ratio of the performance value to the risk budget. This ratio may be similar to the information ratio described above, except that the ratio used to generate the performance management-based quantitative indicator component uses the risk budget, not the carried out risk value, in the denominator of the ratio. This is advantageous for many reasons. For example, using risk budget instead of carried out risk in the ratio may avoid the drawbacks explained above in connection with FIG. 2. An exemplary manner in which the performance management-based quantitative indicator component may be generated will be described below.

The first risk management-based quantitative indicator component (i.e., Qᵣ₁) of Equation 1 may be based on a net number of predetermined time intervals (e.g., a net number of months) within an evaluation time period (e.g., a year) during which the carried out risk value is greater than the risk budget. For example, during a particular year, the carried out risk value may be greater than the risk budget for seven out of twelve months. In this example, the net number of months during which the carried out risk value is greater than the risk budget is two. An exemplary manner in which the first risk management-based quantitative indicator component may be generated based on the net number of predetermined time intervals within an evaluation time period during which the carried out risk value is greater than the risk budget will be described below.

The second risk management-based quantitative indicator component (i.e., Qᵣ₂) of Equation 1 may be based on a quantity of deviation of the carried out risk value with respect to the risk budget. This deviation may be measured in any suitable manner and may be with respect to a particular time period (e.g., a month or a year).

Exemplary mathematical models that may be used to generate the quantitative indicator components described herein will now be described.

The following equation represents an evaluation function that may be maintained by system 300 and that may be used to generate an evaluation score (i.e., a value for a particular quantitative indicator component).

$$S ( m , {p}_{1} , {p}_{2} , {p}_{3} , {p}_{4} , {p}_{5} ) = \{ \begin{matrix}0 , if m \leq {p}_{1} \\ 50 * \frac{( m - {p}_{1} )}{( {p}_{2} - {p}_{1} )} , if {p}_{1} \leq m \leq {p}_{2} \\ 50 + 25 * \frac{( m - {p}_{2} )}{( {p}_{3} - {p}_{2} )} , if {p}_{2} \leq m \leq {p}_{3} \\ 75 + 25 * \frac{( m - {p}_{3} )}{( {p}_{4} - {p}_{3} )} , if {p}_{3} \leq m \leq {p}_{4} \\ 100 + 50 * \frac{( m - {p}_{4} )}{( {p}_{5} - {p}_{4} )} , if {p}_{4} \leq m \leq {p}_{5} \\ 150 , if {p}_{5} \leq m . \end{matrix} \qquad ( Equation 2 )$$

In Equation 2 above, S represents an evaluation score, m is a value of a particular metric (e.g., information ratio, net number of months that carried out risk value is greater than risk budget, quantity of deviation of carried out risk versus risk budget) being given an evaluation score, and p₁ through p₅ are metric values that correspond to the 5th, 25th, 50th, 75th, and 95th percentiles, respectively, of a normal distribution of metric values with a mean of 0 and a variance of 1. As shown, if m is less than or equal to the metric value that corresponds to the 5th percentile, the metric value is given an evaluation score of 0. As another example, if m is in between the metric value that corresponds to the 5th percentile and the metric value that corresponds to the 25th percentile, the metric value is given an evaluation score of 50*(m−p₁)/(p₂−p₁).

Equation 2 may be used to generate each of the quantitative indicator components Qₚ, Qᵣ₁, and Qᵣ₂ included in Equation 1 above. For example, with respect to the performance management-based quantitative indicator component (i.e., Qₚ), the ratio of performance to risk budget may have a known probability distribution of values with a value of −1.64 corresponding to the 5th percentile, a value of −0.67 corresponding to the 25th percentile, a value of 0 corresponding to the 50th percentile, a value of 0.67 corresponding to the 75th percentile, and a value of 1.64 corresponding to the 95th percentile. Hence, using the function shown in Equation 2, the performance management-based quantitative indicator component may be expressed as the following:

$${Q}_{p} = S ( \frac{r}{te} , - 1.64 , - 0.67 , 0 , 0.67 , 1.64 ) \qquad ( Equation 3 )$$

In Equation 3, r represents the performance value, te represents the risk budget (also referred to as the target tracking error), and the S function is that shown in Equation 2 above. As an example, if the performance value (i.e., r) is 4% and risk budget (i.e., te) is 3%, the ratio of r to te is 1.33, which means that m in Equation 2 is between p₄ and p₅. Hence, in this example, the performance management-based quantitative indicator component is 100+50*(1.33−0.67)/(1.64−0.67)=134. While exact values of −1.64, −0.67, 0, 0.67, and 1.64 are used in Equation 3, it will be recognized that slightly different values may alternatively be used. For example, each of the exact values used in Equation 3 may vary plus or minus 0.1.

Equation 2 may also be used to generate the risk management-based quantitative indicators Qᵣ₁ and Qᵣ₂. For example, with respect to Qᵣ₁, the net number of months out of a year that the carried out risk value exceeds the risk budget may have a known probability distribution of values with a value of 11 corresponding to the 5th percentile, a value of 7 corresponding to the 25th percentile, a value of 4 corresponding to the 50th percentile, a value of 2 corresponding to the 75th percentile, and a value of 1 corresponding to the 95th percentile. Hence, using the function shown in Equation 2, the first risk management-based quantitative indicator component may be expressed as the following:

Qᵣ₁=S(−s, −11, −7, −4, −2, −1) (Equation 4)

In Equation 4, s represents the net number of months during a year that the carried out risk value exceeds the risk budget, and the S function is that shown in Equation 2 above. As an example, if s is 5, the variable m in Equation 2 is between p₂ and p₃. Hence, in this example, the first risk management-based quantitative indicator component is 50+25*(−5+7)/(−4+7)=67. While exact values of −11, −7, −4, −2, and −1 are used in Equation 4, it will be recognized that slightly different values may alternatively be used. For example, each of the exact values used in Equation 4 may vary plus or minus 1.

With respect to Qᵣ₂, the quantity of deviation of the carried out risk value with respect to the risk budget may have a known probability distribution of values with a value of 41% corresponding to the 5th percentile, a value of 24% corresponding to the 25th percentile, a value of 14% corresponding to the 50th percentile, a value of 7% corresponding to the 75th percentile, and a value of 1% corresponding to the 95th percentile. Hence, using the function shown in Equation 2, the second risk management-based quantitative indicator component may be expressed as the following:

$${Q}_{r 2} = S ( - \vert \frac{t}{te} - 1 \vert , - 41 \% , - 24 \% , - 14 \% , - 7 \% , - 1 \% ) \qquad ( Equation 5 )$$

In Equation 5, t represents the carried out risk value, te represents the risk budget, and the S function is that shown in Equation 2 above. As an example, if t is 2% and te is 3%, the variable m in Equation 2 is −33% and is therefore between p₁ and p₂. Hence, in this example, the second risk management-based quantitative indicator component is 50*(−33%+41%)/(−24%+41%)=23. While exact values of −41%, −24%, −14%, −7%, and −1% are used in Equation 5, it will be recognized that slightly different values may alternatively be used. For example, each of the exact values used in Equation 5 may vary plus or minus 5%.

Returning to Equation 1, each quantitative indicator component may be weighted to have a desired amount of influence on the overall quantitative indicator generated for a decision making entity. For example, w₁ may be set to 50%, w₂ may be set to 25%, and w₃ may be set to 25% in order to equally weight the performance management-based quantitative indicator component with the combination of risk management-based quantitative indicator components. In this case, the overall quantitative indicator for a decision making entity may be represented by the following equation:

$$Q = \frac{{Q}_{p}}{2} + \frac{{Q}_{r 1}}{4} + \frac{{Q}_{r 2}}{4} \qquad ( Equation 6 )$$

It will be recognized that the weighting factors of Equation 1 may each be set to be any suitable value as may serve a particular implementation.

Using Equations 2-6, an example of generating a quantitative indicator for a decision making entity will now be provided. In this example, the performance value is 4%, the carried out risk value is 2%, and the risk budget is 3%. Using Equations 2-6 above, Qₚ is 134, Qᵣ₁ is 67, and Qᵣ₂ is 23. Hence, Q is 134/2+67/4+23/4=89.5. In contrast, if the conventional information ratio-based evaluation metric were used to evaluate the decision making entity, Q would be equal to 150. However, this score does not take into account risk budget and therefore does not convey how well the decision maker manages both performance and risk.

In some examples, processing facility 304 may generate and present a graphical user interface (“GUI”) on a display associated with system 300. For example, the GUI may be presented on a display screen connected to or integrated into a computing device that implements system 300. Processing facility 304 may present various items within the GUI that are associated with a decision making entity that is being evaluated by processing facility 304.

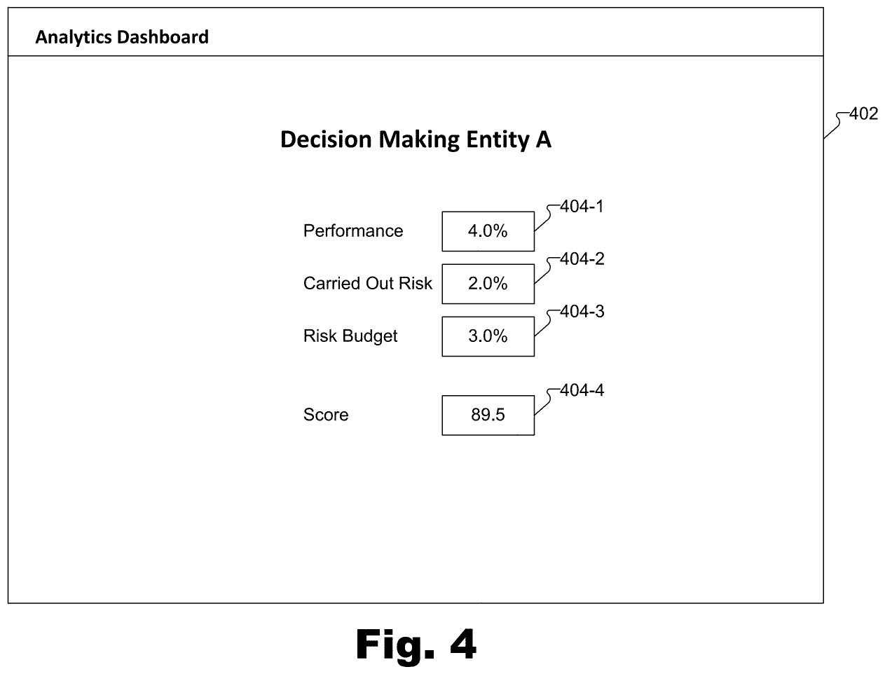

To illustrate, FIG. 4 shows an exemplary GUI 402 that may be presented by processing facility 304. As shown, various items associated with a decision making entity entitled “Decision Making Entity A” are presented within GUI 402. For example, a performance value for the decision making entity is presented within field 404-1, a carried out risk value for the decision making entity is presented within field 404-2, a risk budget for the decision making entity is presented within field 404-3, and an overall quantitative indicator for the decision making entity is presented within field 404-4. It will be recognized that additional or alternative analytics data may be presented within GUI 402 as may serve a particular implementation.

For example, comparison data for multiple decision making entities may be presented within a GUI, such as GUI 402. To illustrate, processing facility 304 may generate quantitative indicators for multiple decision making entities and then present, within a GUI, comparison data for the multiple decision making entities based on the quantitative indicators. For example, processing facility 304 may present a ranked list of decision making entities, based on the quantitative indicators, within the GUI so that a user of the GUI can readily ascertain how effective a particular decision making entity is compared to others.

In some examples, processing facility 304 may be configured to automatically perform one or more operations with respect to a decision making entity based on a quantitative indicator that is generated for the decision making entity. For example, processing facility 304 may determine that a quantitative indicator for a decision making entity is below a predetermined threshold (e.g., below 50). In response, and based on this determination, processing facility 304 may perform one or more operations with respect to the decision making entity. For example, processing facility 304 may provide a notification to the decision making entity and/or another entity (e.g., another user) that the quantitative indicator is below the predetermined threshold. This notification may be provided by way of a GUI (e.g., GUI 402), transmitted to an intended recipient by way of a network to a computing device used by the intended recipient, and/or in any other suitable manner.

Additionally or alternatively, processing facility 304 may transmit, by way of a network to a computing device associated with the decision making entity, data representative of a recommendation to modify a parameter dataset that governs decisions made by the decision making entity. For example, in the case of a portfolio manager, the recommendation may be to modify one or more aspects of the portfolio being managed by the portfolio manager.

In some examples, processing facility 304 may automatically modify a parameter dataset that governs decisions made by the decision making entity based on a quantitative indicator generated for the decision making entity. For example, in the case of a portfolio manager that manages a portfolio, processing facility 304 may modify, based on the quantitative indicator, a parameter dataset stored by system 300 in a manner that is configured to improve the performance achieved by the decision making entity with respect to the portfolio. Processing facility 304 may then apply the modified parameter dataset to the management of the portfolio by, for example, transmitting a command to adjust the portfolio in accordance with the modified parameter dataset to a server by way of a network. The command to adjust the portfolio may include a command to modify the assets included in the portfolio and/or any other command as may serve a particular implementation.

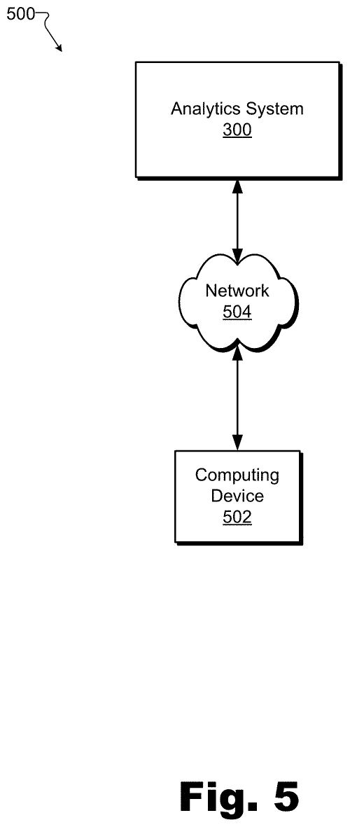

FIG. 5 shows an exemplary configuration 500 in which analytics system 300 may be selectively and communicatively coupled to a computing device 502 by way of a network 504. Computing device 502 may include a server, mobile device (e.g., a mobile phone), a personal computer, and/or any other type of computing device as may serve a particular implementation. Computing device 502 may be associated with (e.g., used by) any suitable user or entity, such as a decision making entity, a brokerage, an analyst, a consumer, a stock exchange, etc.

Network 504 may include a provider-specific wired or wireless network (e.g., a cable or satellite carrier network or a mobile telephone network), the Internet, a wide area network, a content delivery network, or any other suitable network. Data may flow between analytics system 300 and computing device 502 using any communication technologies, devices, media, and protocols as may serve a particular implementation.

In some examples, analytics system 300 may receive data used to determine a performance value, a carried out risk value, and/or a risk budget from computing device 502 by way of network 504. Additionally or alternatively, analytics system 300 may transmit data to computing device 502 by way of network 504. For example, analytics system 300 may transmit data representative of a notification, a recommendation, and/or a command to modify a parameter dataset that governs a management of a portfolio to computing device 502 by way of network 504.

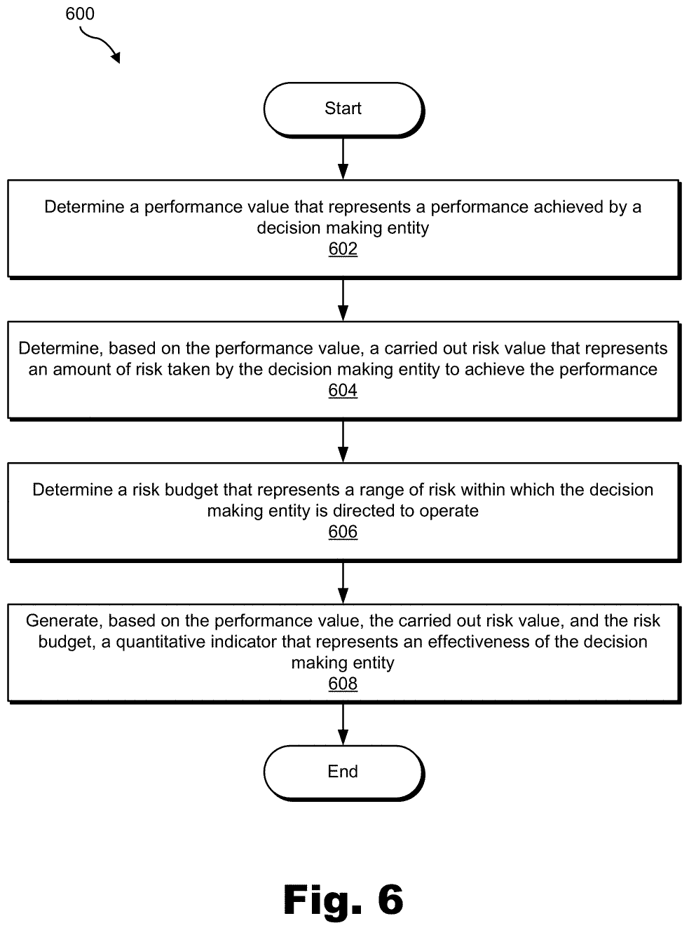

FIG. 6 illustrates an exemplary risk-budget based decision making entity analytics method 600. While FIG. 6 illustrates exemplary operations according to one embodiment, other embodiments may omit, add to, reorder, and/or modify any of the operations shown in FIG. 6. One or more of the operations shown in FIG. 6 may be performed by system 300 and/or any implementation thereof.

In operation 602, an analytics system determines a performance value that represents a performance achieved by a decision making entity. Operation 602 may be performed in any of the ways described herein.

In operation 604, the analytics system determines, based on the performance value, a carried out risk value that represents an amount of risk taken by the decision making entity to achieve the performance. Operation 604 may be performed in any of the ways described herein.

In operation 606, the analytics system determines a risk budget that represents a range of risk within which the decision making entity is directed to operate. Operation 606 may be performed in any of the ways described herein.

In operation 608, the analytics system generates, based on the performance value, the carried out risk value, and the risk budget, a quantitative indicator that represents an effectiveness of the decision making entity. Operation 608 may be performed in any of the ways described herein.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

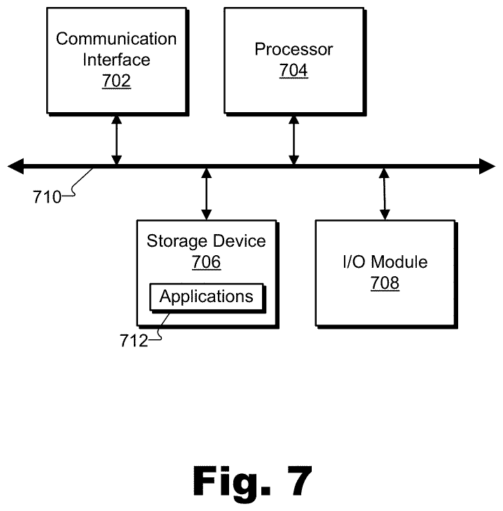

FIG. 7 illustrates an exemplary computing device 700 that may be specifically configured to perform one or more of the processes described herein. As shown in FIG. 7, computing device 700 may include a communication interface 702, a processor 704, a storage device 706, and an input/output (“I/O”) module 708 communicatively connected via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data or interpreting, executing, and/or directing execution of one or more of the instructions, processes, and/or operations described herein. Processor 704 may direct execution of operations in accordance with one or more applications 712 or other computer-executable instructions such as may be stored in storage device 706 or another computer-readable medium.

Storage device 706 may include one or more data storage media, devices, or configurations and may employ any type, form, and combination of data storage media and/or device. For example, storage device 706 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 706. For example, data representative of one or more executable applications 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. One or more I/O modules may be used to receive input for a single virtual reality experience. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 700. For example, one or more applications 712 residing within storage device 706 may be configured to direct processor 704 to perform one or more processes or functions associated with processing facility 304. Likewise, storage facility 302 may be implemented by or within storage device 702.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A method comprising:
determining, by a physical computing device, a performance value that represents a performance achieved by a decision making entity;
determining, by the physical computing device, based on the performance value, a carried out risk value that represents an amount of risk taken by the decision making entity to achieve the performance;
determining, by the physical computing device, a risk budget that represents a range of risk within which the decision making entity is directed to operate; and
generating, by the physical computing device based on the performance value, the carried out risk value, and the risk budget, a quantitative indicator that represents an effectiveness of the decision making entity by
determining a ratio of the performance value to the risk budget,
generating, based on the ratio of the performance value to the risk budget, a performance management-based quantitative indicator component,
determining a net number of predetermined time intervals within an evaluation time period during which the carried out risk value is greater than the risk budget,
generating, based on the net number, a first risk management-based quantitative indicator component,
determining a quantity of deviation of the carried out risk value with respect to the risk budget,
generating, based on the quantity of deviation of the carried out risk value with respect to the risk budget, a second risk management-based quantitative indicator component, and
combining the performance management-based quantitative indicator component, the first risk management-based quantitative indicator component, and the second risk management-based quantitative indicator component; and
maintaining, by the physical computing device, an evaluation function that is used to generate each of the performance management-based quantitative indicator component, the first risk management-based quantitative indicator component, and the second risk management-based quantitative indicator component.

2. The method of claim 1, wherein:
the evaluation function is set forth as
$$S ( m , {p}_{1} , {p}_{2} , {p}_{3} , {p}_{4} , {p}_{5} ) = \{ \begin{matrix}0 , if m \leq {p}_{1} \\ 50 * \frac{( m - {p}_{1} )}{( {p}_{2} - {p}_{1} )} , if {p}_{1} \leq m \leq {p}_{2} \\ 50 + 25 * \frac{( m - {p}_{2} )}{( {p}_{3} - {p}_{2} )} , if {p}_{2} \leq m \leq {p}_{3} \\ 75 + 25 * \frac{( m - {p}_{3} )}{( {p}_{4} - {p}_{3} )} , if {p}_{3} \leq m \leq {p}_{4} \\ 100 + 50 * \frac{( m - {p}_{4} )}{( {p}_{5} - {p}_{4} )} , if {p}_{4} \leq m \leq {p}_{5} \\ 150 , if {p}_{5} \leq m , \end{matrix}$$
the generating of the performance management-based quantitative indicator component comprises computing the evaluation function with m equal to r/te, p₁ equal to −1.64 plus or minus 0.1, p₂ equal to −0.67 plus or minus 0.1, p₃ equal to 0 plus or minus 0.1, p₄ equal to 0.67 plus or minus 0.1, and p₅ equal to 1.64 plus or minus 0.1, with r representative of the performance value and to representative of the risk budget;
the generating of the first risk management-based quantitative indicator component comprises computing the evaluation function with m equal to −s, p₁ equal to −11 plus or minus 1, p₂ equal to −7 plus or minus 1, p₃ equal to −4 plus or minus 1, p₄ equal to −2 plus or minus 1, and p₅ equal to −1 plus or minus 1, with s representative of the net number; and
the generating of the second risk management-based quantitative indicator component comprises computing the evaluation function with m equal to −|t/te−1|, p₁ equal to −41% plus or minus 5%, p₂ equal to −24% plus or minus 5%, p₃ equal to −14% plus or minus 5%, p₄ equal to −7% plus or minus 5%, and p₅ equal to −1% plus or minus 5%, with t representative of the carried out risk value and to representative of the risk budget.

3. The method of claim 1, wherein the combining comprises weighting the performance management-based quantitative indicator component to be 50 percent of the quantitative indicator, weighting the first risk management-based quantitative indicator component to be 25 percent of the quantitative indicator, and weighting the second risk management-based quantitative indicator component to be 25 percent of the quantitative indicator.

4. The method of claim 1, further comprising presenting, by the physical computing device, the quantitative indicator within a graphical user interface.

5. The method of claim 1, further comprising:
determining, by the physical computing device, that the quantitative indicator is below a predetermined threshold; and
performing, by the physical computing device based on the determining that the quantitative indicator is below the predetermined threshold, an operation with respect to the decision making entity.

6. The method of claim 5, wherein the performance achieved by the decision making entity is with respect to a portfolio that the decision making entity actively manages, and wherein the operation comprises at least one of:
providing a notification to at least one of the decision making entity and another entity that the quantitative indicator is below the predetermined threshold; and
transmitting, by way of a network to a computing device associated with the decision making entity, data representative of a recommendation to modify a parameter dataset that governs the active management by the decision making entity of the portfolio.

7. The method of claim 1, further comprising:
generating an additional quantitative indicator that represents an effectiveness of an additional decision making entity; and
presenting, by way of a graphical user interface and based on the quantitative indicator and the additional quantitative indicator, comparison data for the decision making data and the additional decision making entity.

8. The method of claim 1, wherein the determining of the performance value comprises:
determining a return achieved by a portfolio managed by the decision making entity;
determining a return of a benchmark; and
determining a difference between the return achieved by the portfolio managed by the decision making entity and the return of the benchmark.

9. The method of claim 1, wherein the determining of the carried risk value comprises determining a standard deviation of a plurality of performance values for the portfolio and that include the performance value.

10. The method of claim 1, wherein the determining of the risk budget comprises receiving data representative of the risk budget by way of a network.

11. (canceled)

12. A method comprising:
receiving, by a physical computing device configured to actively manage a portfolio in accordance with a parameter dataset stored in memory of the physical computing device, data representative of a return achieved by the portfolio managed by the physical computing device;
generating, by the physical computing device, a performance value that represents a performance achieved by the physical computing device with respect to the portfolio by comparing the return achieved by the portfolio to a return of a benchmark;
determining, by the physical computing device, based on the performance value, a carried out risk value that represents an amount of risk taken by the physical computing device to achieve the performance;
determining, by the physical computing device, a risk budget that represents a range of risk within which the physical computing device is directed to operate while managing the portfolio;
generating, by the physical computing device based on the performance value, the carried out risk value, and the risk budget, a quantitative indicator that represents an effectiveness of the physical computing device in managing the portfolio;
modifying, by the physical computing device based on the quantitative indicator, the parameter dataset stored by the physical computing device in a manner that is configured to improve the performance achieved by the physical computing device with respect to the portfolio; and
applying, by the physical computing device, the modified parameter dataset to the management of the portfolio by transmitting, to a server by way of a network, a command to adjust the portfolio in accordance with the modified parameter dataset,
wherein the generating of the quantitative indicator includes imputing the performance value, the carried out risk value, and the risk budget into an evaluation function maintained by the physical computing device.

13. (canceled)

14. A system comprising:
a physical computing device that
determines a performance value that represents a performance achieved by a decision making entity;
determines, based on the performance value, a carried out risk value that represents an amount of risk taken by the decision making entity to achieve the performance;
determines a risk budget that represents a range of risk within which the decision making entity is directed to operate; and
generates, based on the performance value, the carried out risk value, and the risk budget, a quantitative indicator that represents an effectiveness of the decision making entity by
determining a ratio of the performance value to the risk budget,
generating, based on the ratio of the performance value to the risk budget, a performance management-based quantitative indicator component,
determining a net number of predetermined time intervals within an evaluation time period during which the carried out risk value is greater than the risk budget,
generating, based on the net number, a first risk management-based quantitative indicator component,
determining a quantity of deviation of the carried out risk value with respect to the risk budget,
generating, based on the quantity of deviation of the carried out risk value with respect to the risk budget, a second risk management-based quantitative indicator component, and
combining the performance management-based quantitative indicator component, the first risk management-based quantitative indicator component, and the second risk management-based quantitative indicator component; and
maintains an evaluation function that is used to generate each of the performance management-based quantitative indicator component, the first risk management-based quantitative indicator component, and the second risk management-based quantitative indicator component.

15. The system of claim 14, wherein:
the evaluation function is set forth as
$$S ( m , {p}_{1} , {p}_{2} , {p}_{3} , {p}_{4} , {p}_{5} ) = \{ \begin{matrix}0 , if m \leq {p}_{1} \\ 50 * \frac{( m - {p}_{1} )}{( {p}_{2} - {p}_{1} )} , if {p}_{1} \leq m \leq {p}_{2} \\ 50 + 25 * \frac{( m - {p}_{2} )}{( {p}_{3} - {p}_{2} )} , if {p}_{2} \leq m \leq {p}_{3} \\ 75 + 25 * \frac{( m - {p}_{3} )}{( {p}_{4} - {p}_{3} )} , if {p}_{3} \leq m \leq {p}_{4} \\ 100 + 50 * \frac{( m - {p}_{4} )}{( {p}_{5} - {p}_{4} )} , if {p}_{4} \leq m \leq {p}_{5} \\ 150 , if {p}_{5} \leq m , \end{matrix}$$
the generation of the performance management-based quantitative indicator component comprises computing the evaluation function with m equal to r/te, p₁ equal to −1.64 plus or minus 0.1, p₂ equal to −0.67 plus or minus 0.1, p₃ equal to 0 plus or minus 0.1, p₄ equal to 0.67 plus or minus 0.1, and p₅ equal to 1.64 plus or minus 0.1, with r representative of the performance value and te representative of the risk budget;
the generation of the first risk management-based quantitative indicator component comprises computing the evaluation function with m equal to −s, p₁ equal to −11 plus or minus 1, p₂ equal to −7 plus or minus 1, p₃ equal to −4 plus or minus 1, p₄ equal to −2 plus or minus 1, and p₅ equal to −1 plus or minus 1, with s representative of the net number; and
the generation of the second risk management-based quantitative indicator component comprises computing the evaluation function with m equal to −|t/te−1|, p₁ equal to −41% plus or minus 5%, p₂ equal to −24% plus or minus 5%, p₃ equal to −14% plus or minus 5%, p₄ equal to −7% plus or minus 5%, and p₅ equal to −1% plus or minus 5%, with t representative of the carried out risk value and te representative of the risk budget.

16. The system of claim 14, wherein the combining comprises weighting the performance management-based quantitative indicator component to be 50 percent of the quantitative indicator, weighting the first risk management-based quantitative indicator component to be 25 percent of the quantitative indicator, and weighting the second risk management-based quantitative indicator component to be 25 percent of the quantitative indicator.

17. The system of claim 14, wherein the physical computing device presents the quantitative indicator within a graphical user interface.

18. The system of claim 14, wherein the physical computing device:
determines that the quantitative indicator is below a predetermined threshold; and
performs, based on the determination that the quantitative indicator is below the predetermined threshold, an operation with respect to the decision making entity.

19. The system of claim 14, wherein the physical computing device:
generates an additional quantitative indicator that represents an effectiveness of an additional decision making entity; and
presents, by way of a graphical user interface and based on the quantitative indicator and the additional quantitative indicator, comparison data for the decision making data and the additional decision making entity.

20. The system of claim 14, wherein the physical computing device:
determines a return achieved by a portfolio managed by the decision making entity;
determines a return of a benchmark; and
determines a difference between the return achieved by the portfolio managed by the decision making entity and the return of the benchmark.
